(19) United States
(12) Patent Application Publication
(10) Pub. No.: US 2006/0077136 A1
(43) Pub. Date: Apr. 13, 2006

(54) System for controlling an OLED display

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/962,020

(22) Filed: Oct. 8, 2004

(51) Int. Cl. G09G 3/30

(52) U.S. Cl. 345/76

(57) ABSTRACT

A system for controlling an OLED device having an output that changes with time or use is described, comprising: a) an OLED device responsive to a corrected input signal having one or more light emitting elements and a temperature sensor for sensing the temperature of the OLED device to produce a temperature signal; b) a controller including: i) a first calculation circuit responsive to the temperature signal, a corrected digital input signal, and a pre-determined aging function to produce a digital aging value corresponding to the aging of the light emitting elements; ii) an accumulation circuit for integrating the digital aging value over time to provide a digital accumulated aging value; iii) a second calculation circuit responsive to the digital accumulated aging value for calculating a digital correction signal; and iv) a transformation circuit responsive to a digital input signal and the digital correction signal for transforming the digital input signal to the corrected digital input signal.

### FIELD OF THE INVENTION

The present invention relates to solid-state OLED flat-panel display devices and more particularly to systems and methods for controlling an OLED device having an output that changes with time or use to compensate for the aging of the organic light emitting display.

### BACKGROUND OF THE INVENTION

Solid-state organic light emitting diode (OLED) image display devices are of great interest as a superior flat-panel display technology. These displays utilize current passing through thin films of organic material to generate light. The color of light emitted and the efficiency of the energy conversion from current to light are determined by the composition of the organic thin-film material. Different organic materials emit different colors of light. However, as the display is used, the organic materials in the device age and become less efficient at emitting light thereby reducing the lifetime of the display. The differing organic materials may age at different rates, causing differential color aging and a display whose white point varies as the display is used.

Referring to FIG. 5, a graph illustrating the typical light output of a prior-art OLED display device as current is passed through the OLEDs at a fixed rate over time is shown. Hence, the aging of the OLED device is related to the cumulative current passed through the OLED device. The three curves represent typical changes in performance of red, green and blue light emitters over time. As can be seen by the curves, the decay in luminance between the differently colored light emitters is different. Hence, in conventional use, with no aging correction, as current is applied to each of the differently colored OLEDs, the display will become less bright and the color, in particular the white point, of the display will shift.

A variety of means to correct for the changes in OLED efficiency and brightness over time are proposed in the art. One technique relies on sensing the light output by the device and compensating a driver in response. Luminance sensing can be done internally to an active-matrix pixel or externally on a more global basis. Such methods require the integration of optical sensors, greatly increases complexity, and reduces yields in a display. A second technique measures the performance of a proxy, for example an extra pixel element to estimate the aging of the OLED device. This approach has the disadvantage of assuming that the behavior of the proxy element is identical to that of the OLED itself. A third approach relies on measurement of current or voltage used within a pixel, but this approach requires additional circuitry in each pixel of an active-matrix device. A fourth technique relies upon measuring and integrating the current used by the OLED device over time. However, through experimentation, applicant has determined that such measures are inadequate to reliably compensate for the aging of an OLED device. Moreover, the additional circuitry necessary to measure the instantaneous current for each pixel is complex and error-prone. It is also known to estimate the aging of an OLED device by employing a mathematical model and assumptions about the intended use and operational environment of the device.

U.S. Pat. No. 6,414,661 B1 entitled “Method and apparatus for calibrating display devices and automatically compensating for loss in their efficiency over time” by Shen et al issued Jul. 02, 2002 describes a method and associated system that compensates for long-term variations in the light-emitting efficiency of individual organic light emitting diodes (OLEDs) in an OLED display device, calculates and predicts the decay in light output efficiency of each pixel based on the accumulated drive current applied to the pixel and derives a correction coefficient that is applied to the next drive current for each pixel. In one exemplary embodiment of the invention, the calculation is based on the accumulated current that has been passed through the device. In another exemplary embodiment, the calculation is based on a difference in voltage across the pixel at two instants. This solution requires that the operating time of the device be tracked by a timer within the controller which then provides a compensating amount of current. This requires extensive timing, calculation, and storage circuitry in the controller. Also, this technique does not accommodate differences in behavior of the display at varying levels of brightness and temperature and cannot accommodate differential aging rates of the different organic materials. Alternatively, the instantaneous current-voltage characteristic of a pixel within a display may be monitored, requiring additional circuitry on the display device itself, thereby increasing display complexity and reducing yields.

US 20030048243 A1 entitled “Compensating organic light emitting device displays for temperature effects” published Mar. 13, 2003, discloses the use of temperature sensing in combination with integrated charge measurement in OLED device compensation systems. While such proposed system takes into account operational temperature of the OLED in calculating rate of degradation, similar as with U.S. Pat. No. 6,414,661 B1, the requirement of current integrated charge measurements requires additional circuitry, thereby increasing display complexity and reducing yields.

U.S. Pat. No. 6,504,565 B1issued Jan. 7, 2003 to Narita et al., describes a light-emitting device which includes a light-emitting element array formed by arranging a plurality of light-emitting elements, a driving unit for driving the light-emitting element array to emit light from each of the light-emitting elements, a memory unit for storing the number of light emissions for each light-emitting element of the light-emitting element array, and a control unit for controlling the driving unit based on the information stored in the memory unit so that the amount of light emitted from each light-emitting element is held constant. An exposure device employing the light-emitting device, and an image forming apparatus employing the exposure device are also disclosed. However, the need for an additional image forming device raises costs and complexity.

US 20030071804 entitled “Light Emitting Device And Electronic Apparatus Using The Same” published Apr. 17, 2003 describes accumulating a sampled signal, and performing a voltage power supply correction in combination with signal correction to compensate for OLED device and pixel aging. The described system requires complex variable power circuitry, however, does not accommodate aging variations due to: environmental conditions, does not account for increased aging that may be associated with employing a corrected input signal, and does not address initial non-uniformity issues, in particular pixels which may be stuck on or stuck off.

All of the methods described above change the output of the OLED display to compensate for changes in the OLED light emitting elements. However, it is preferable that any changes made to the display be imperceptible to a user. Since displays are typically viewed in a single-stimulus environment, slow changes over time are acceptable, but large, noticeable changes are objectionable. Since continuous, real-time corrections are usually not practical because they interfere with the operation of the OLED display, most changes in OLED display compensation are done periodically. Hence, if an OLED display output changes significantly during a single period, a noticeably objectionable correction to the appearance of the display may result.

OLED devices are known to decay very quickly when first used. As time goes by, the decrease in efficiency slows. In order to decrease the perceptibility of OLED aging, it is possible to first age the device during the manufacturing process so that, after the aging is completed, the decay rate is reduced and is less perceptible and more acceptable to a user. For example, “US 20020123291 A1” entitled “Manufacturing method of organic EL element” published Sep. 05, 2002 describes performing an aging treatment. In the aging treatment, a curve of change in luminance with time is measured in driving the organic EL element at constant current. Then, the curve of change in luminance with time is divided into a component having a slowest luminance age-deterioration rate and other components by analyzing the curve and forming a fitting curve having a plurality of members that is fitted to the curve of change in luminance with time. Moreover, the aging treatment is conducted until a luminance of the element becomes approximately equal to an initial value A1 of the component having a slowest luminance age-deterioration rate. While this is useful in correcting the initial performance of an OLED device, it does not provide means for correcting increasing device inefficiency over time.

OLED devices often suffer from non-uniformities between pixels in a multi-pixel device. Such non-uniformity is attributable to a lack of control and manufacturing and can affect electronic elements and organic materials and coatings in the OLED devices. These non-uniformities may be corrected be measuring the non-uniformity and providing a calculated correction intended to cause all of the light emitting elements to emit the same amount of light. Techniques such as a measurement of current variability in an OLED or a measurement of the actual light output may be employed to measure the non-uniformity. However, unless periodic recalibration is performed, such techniques do not compensate for OLED device aging or manufacturing variability.

It is also true that in any real system, measurement anomalies may occur due to environmental or system perturbations or noise that do not reflect the actual situation. Corrections in response to such anomalies are undesirable and may result in damage to the system or may degrade display performance. Manufacturing processes used to make OLED displays also exhibit variability that affects the performance of the display and this manufacturing variability needs to be accommodated in any practical aging correction method.

It is also the case that some environmental factors, for example temperature of operation, length of operation, and time since previous operation all contribute to the efficiency of the display. It is difficult to accommodate all environmental factors in a correction scheme. Therefore, it is important to provide corrections that are robust in the face of unanticipated-environmental variables. The methods shown in the prior art do not address these environmental variables.

There is a need therefore for an improved aging compensation method for organic light emitting diode displays.

### SUMMARY OF THE INVENTION

In accordance with one embodiment, the present invention is directed towards a system for controlling an OLED device having an output that changes with time or use comprising:

a) an OLED device responsive to a corrected input signal having one or more light emitting elements and a temperature sensor for sensing the temperature of the OLED device to produce a temperature signal;

b) a controller including:
i) a first calculation circuit responsive to the temperature signal, a corrected digital input signal, and a pre-determined aging function to produce a digital aging value corresponding to the aging of the light emitting elements;
ii) an accumulation circuit for integrating the digital aging value over time to provide a digital accumulated aging value;
iii) a second calculation circuit responsive to the digital accumulated aging value for calculating a digital correction signal; and
iv) a transformation circuit responsive to a digital input signal and the digital correction signal for transforming the digital input signal to the corrected digital input signal.

In accordance with another embodiment, the present invention is directed towards a system for the control and correction of an OLED device having one or more light emitting elements having an output that changes with time or use comprising a single input signal transformation circuit for the correction of non-uniformity within the OLED device, overall aging of the overall OLED device, and differential light emitting element aging of the overall OLED device.

In accordance with a further embodiment, the present invention is directed towards a method for controlling an OLED device having one or more light emitting elements having an output that changes with time or use, comprising:

a) determining an aging function for the light emitting elements of the device;

b) driving the OLED device with a corrected digital input signal;

c) measuring the temperature of the OLED device;

d) calculating a digital aging value from the aging function, measured temperature and the corrected digital input signal;

e) accumulating and storing a digital accumulated aging value by integrating the digital aging value over time;

f) calculating a digital correction signal for the OLED device using the aging function and the digital accumulated aging value; and

g) correcting a digital input signal with the digital correction signal to form the corrected digital input signal.

### ADVANTAGES

The advantages of this invention are systems and methods for operating an OLED device to compensate for reduced light emitting efficiency over time that accommodates manufacturing variability and provides a simple implementation.

### BRIEF DESCRIPTION OF THE DRAWINGS

FIG. 1 is a diagram of one embodiment of the present invention;

FIG. 2 is a flowchart illustrating a method of operation of the present invention;

FIG. 3 is a graph illustrating the relationship between a correction signal and an accumulated charge for two color OLED devices aged at different temperatures;

FIG. 4 is a graph illustrating the relationship between brightness and time at a constant power as is known in the prior art.

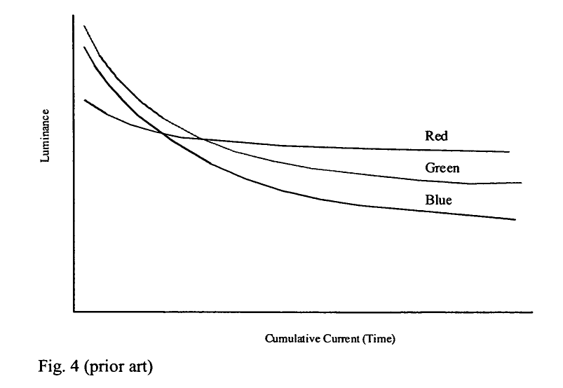

### DETAILED DESCRIPTION OF THE INVENTION

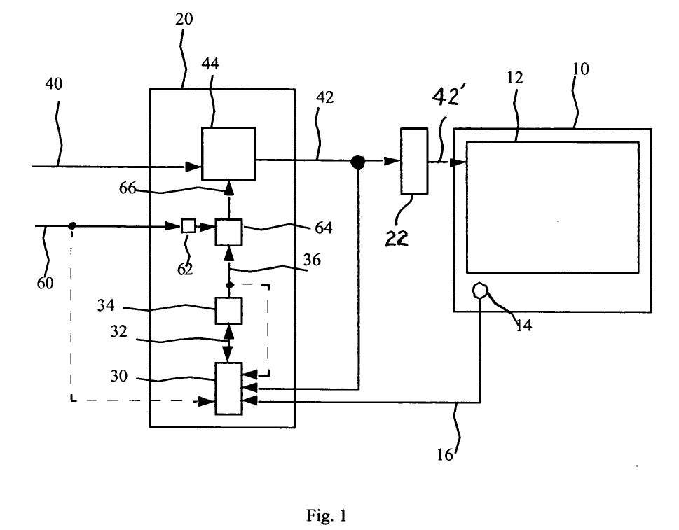

Referring to FIG. 1, a system for controlling an OLED device having an output that changes with time or use comprises an OLED device 10 responsive to a corrected digital input signal 42 having an array of one or more light emitting elements 12 and a temperature sensor 14 for sensing the temperature of the OLED device 10 and producing a temperature signal 16; a controller 20 including: a first calculation circuit 30 responsive to the temperature signal 16, the digital corrected input signal 42, and a pre-determined aging function to produce a digital aging value 32 corresponding to the aging of the light emitting elements; an accumulation circuit 34 for integrating the digital aging value 32 over time to provide a digital accumulated aging value 36; a storage circuit 62 responsive to a uniformity correction signal 60; a second calculation circuit 64 responsive to the storage circuit 62 and the digital accumulated aging value 36 for calculating a digital correction signal 66; and a transformation circuit 44 responsive to a digital input signal 40 and the digital correction signal 66 for transforming the digital input signal 40 to a digital corrected input signal 42. In a simplified embodiment of the present invention, the storage circuit 62 may be omitted and a uniformity correction not implemented. The first calculation circuit 30 may also be responsive to the digital accumulated aging value 36 and/or also responsive to the uniformity correction signal 60.

The circuits of the present invention may be implemented in a variety of ways. For example, discrete digital circuits may be employed using combinational logic and memories. Alternatively, programmable devices using controllers and memories may be employed. In particular, the storage and/or accumulation circuits may comprise one or more memories and the calculation circuits may comprise one or more programmable computing devices having a program. Digital correction and storage circuits are preferred for use in the present invention because they provide accuracy, simplicity, and a large accumulator range. In one embodiment, the transformation circuit 24 is a lookup table using a memory. All of these components are known in the art and may be implemented within a common integrated circuit or may comprise two or more integrated circuits. OLED devices are typically controlled through analog signals. As the corrected input signal is a digital signal, digital corrected input signal 42 may be converted by a DAC to an analog corrected input signal 42′. Such a DAC may be integrated into the OLED device or into the controller, or formed in a separate circuit.

It is anticipated that the transformation circuit 44, if implemented with a lookup table, may only be modified periodically or in response to an external event. In particular, the aging of an OLED device is relatively slow so that corrections to the transformation may be done only occasionally, for example periodically or in response to an external signal. Hence, the correction may be updated relatively infrequently, for example at power-up or power-down of an OLED device, at periodic intervals, when the accumulated aging value reaches certain levels, or if an operator signals the need for an updated correction.

Because the OLED device may only be updated occasionally and because the correction is based on a cumulative value, it is helpful to employ non-volatile memory that maintains its stored information in the absence of power, for example when an OLED device is turned off.

Since the aging over time of the OLED device is highly non-linear, either the first calculation circuit 30 or second calculation circuit 64 must provide a non-linear transformation to produce the correction signal 66. This non-linear transformation may be provided in either the first calculation circuit 30 (in which case the accumulated aging value 36 must be fed back to the first calculation ciruit, shown by a dotted line in FIG. 1) or in the second calculation circuit 34.

The system of the present invention should provide an initialized state wherein the accumulated aging value 34 is set to zero. Likewise, the transformation circuit 44 initially passes the digital input signal 40 directly to the digital corrected input signal 42, that is the signals are the same. This is easily accomplished, if the transformation circuit 44 is a lookup table, by setting the input and the output of the lookup table to the same value.

The uniformity correction signal 60 is optional. Since uniformity and aging compensation both require a transformation circuit and may usefully employ initial calibration data on the brightness and uniformity of the OLED device under a variety of circumstances (for example at different brightness levels), however, it is convenient to integrate the two corrections together to address non-uniformity, aging of the overall OLED device, and differential pixel aging with one solution. Accordingly, in a specific embodiment the invention is directed towards a system for the control and correction of an OLED device having one or more light emitting elements having an output that changes with time or use comprising a single input signal transformation circuit for the correction of non-uniformity within the OLED device, overall aging of the overall OLED device, and differential light emitting element aging of the overall OLED device.

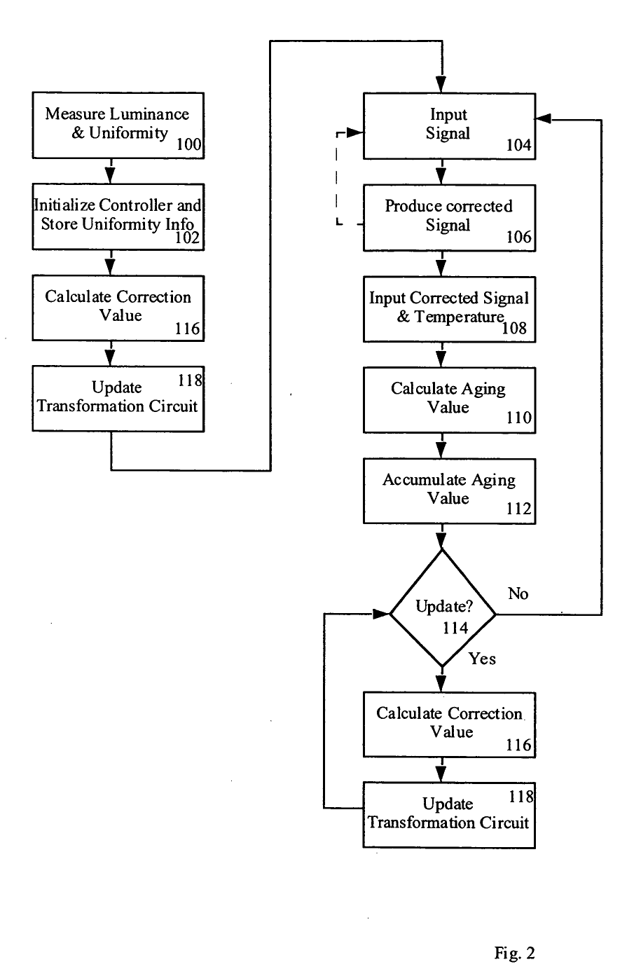

In operation, the controller is first initialized. Referring to FIG. 2, the uniformity and brightness of an OLED device is measured 100, typically by an external system including a digital camera for recording the output of the OLED device displaying a flat field at a variety of brightness levels. This data is stored in the controller 20 and the transformation circuit 44 and aging value accumulator 34 are initialized 102. The aging value accumulator 34 is set to zero. An initial correction value is calculated 116 and the transformation circuit updated 118. If the OLED is completely uniform, the correction value will be null, that is the transformation circuit 44 will match the output to the input, as described above. However, if the OLED is non-uniform, the correction value will compensate for the non-uniformity and the transformation circuit will employ the correction to form a corrected input signal that will compensate for the non-uniformity. The correction may be a multiplication of the input signal by a correction factor to form a corrected brightness level for each OLED light emitter in the OLED device. Alternatively, a non-linear correction transformation may be used in place of the multiplication. Correction calculations for brightness non-uniformity are known in the prior art.

After the aging value accumulator 34 and the transformation circuit 44 are initialized 102 and updated 118, a signal may be input 104 to produce 106 a corrected input signal 42 by the transformation circuit 44. The corrected input signal 42 is applied to the OLED device to operate it. The process of inputting a signal, transforming it, and supplying it to the OLED device can continue independently and indefinitely as shown by the dashed feedback arrow in FIG. 2. At the same time, the corrected input signal 42 and the temperature signal 16 are input 108 to the first calculation circuit 30. The first calculation circuit 30 calculates 110 an aging value from the corrected input signal 42, the accumulated aging value, and the temperature signal 16. The resulting aging value 32 is accumulated 112 in the aging value accumulator 34 by adding it to the accumulated aging value 36 to form a new accumulated aging value 36.

If no correction update 114 is necessary, each time a corrected output value is supplied to the OLED device, an aging value is accumulated and no other action is taken. However, at some point in time a decision is made to update 114 the correction performed by the transformation circuit 44. The decision can be made for a variety of reasons, as described above. Once the decision to update the transformation circuit is made, a new correction value 66 is calculated 116 and the transformation circuit 44 is updated 118. The correction value 66 is based on the uniformity information stored in storage circuit 62 and the accumulated aging value 36 stored in the accumulation circuit 34. Thereafter, the transformation circuit 44 will apply the new correction value to transform the input signal 40 to the corrected input signal 44.

The aging value 32 is dependent on the current age of the OLED device. As time passes and the OLED device is used, the rate of aging slows. This slowing is accommodated by the first calculation circuit 30 that employs a non-linear function to combine the current accumulated aging value 36, the temperature signal 16, and the corrected input signal 42 to create an aging value 32. Further, as the calculation circuit 30 is dependent upon the corrected input value 42, it advantageously accounts for increased aging due to application of the corrected signal, which may differentiate from the anticipated degradation from the uncorrected input signal alone. This difference may be particularly important in the latter stages of an OLED device's life, because as an OLED device ages, the correction grows larger and accelerates the aging of the OLED device materials.

Through experimentation, applicants have also determined that the brightness of the OLED device at a given current or input signal is dependent on the temperature of the OLED device. In order to accommodate this effect, the temperature signal 16 may be employed by the transformation circuit 44 to calculate the corrected input signal 42 (not shown in FIG. 1).

As noted above, the transformation circuit 44 may be implemented with a lookup table. However, the transformation circuit may combine the input signal, the combined correction signal 66, and the temperature signal 16 with a non-linear function. In this case, the size of the lookup table may be too large. In an alternative embodiment, the transformation circuit 44 may comprise a series of sequential transformations, each of which may be a separate lookup table, multiplier, or adder. Such an approach may also improve the speed of the transformation since the computation may be pipelined with separate stages operating in parallel for each calculation step and with intermediate storage elements for intermediate values. For example, digital lookup tables, multipliers, and adders may be used.

The size of the aging accumulator must be chosen to accommodate the expected lifetime of the OLED device. In a typical video application, a separate input signal is sent to the device 30 times per second. These signals conventionally have an 8-bit value. If the aging value calculated from the temperature signal and the corrected input values have a 10-bit value, a 48-bit accumulated value will correspond to a lifetime greater than 290 years of continuous operation, more than adequate for most applications. Hence a 48-bit accumulator for the aging accumulator 34 and a 48-bit first calculation circuit 30 are adequate.

Most OLED devices have more than one color. The materials generating the different colors may themselves be different and age at different rates. In this case, separate controller circuitry may be employed for each color, using different uniformity correction signals 60 and calculations for the first and second calculation circuits 30 and 64. In other embodiments, a single kind of OLED white-light emitter is used and color filters employed to create different colors from the white light. In this case, the aging characteristics of the differently colored pixels are identical and a common set of calculations may be used for the different colors. It may be useful, in any case, to use separate circuitry for each color to improve the speed of computation in the circuits.

Through experimentation, applicants have determined that the efficiency of light emission from a particular OLED device may differ from that of another OLED device, even when made through the same manufacturing process. In this case, it is useful to measure the initial performance of the OLED device. The initial performance of the OLED device is then used to generate parameters used in the transformation and/or calculation circuits to determine the appropriate correction and aging values. Applicants have determined the transformation and calculation functions empirically by actually measuring the current passed through the OLED devices and measuring the light output from the devices over time at a variety of temperatures and brightness levels.

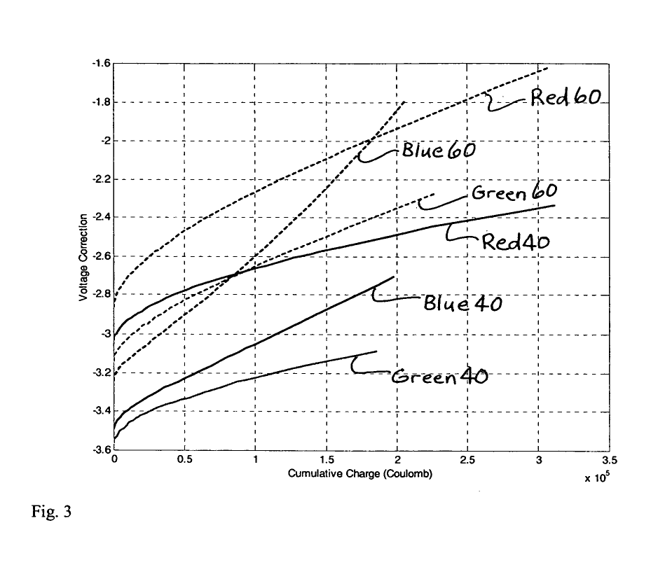

Referring to FIG. 3, a graph illustrates the relationship between the cumulative charge passed through an OLED and a correction voltage necessary to maintain a constant luminance in the OLED device for each of three different light emitting materials (red, green, and blue) in two devices used at two different temperatures (40° C. and 60° C.). In this graph, the lines marked Red40 and Red60 refer to the correction voltage necessary to maintain a constant luminance in the OLED device for a red light emitter aged at 40° C. and 60° C. respectively. The lines marked Green40 and Green60 refer to the correction voltage necessary to maintain a constant luminance in the OLED device for a green light emitter aged at 40° C. and 60° C. respectively. The lines marked Blue40 and Blue60 refer to the correction voltage necessary to maintain a constant luminance in the OLED device for a blue light emitter aged at 40° C. and 60° C. respectively. These curves are empirically determined by applicant through experiment and rely on the use of commercially available materials and OLED devices.

In comparing the pairs of correction curves for each color, one can note that some of the curves are linear over only a portion of the lifetime of the device, contrary to assertions in the prior art. For example, all materials age more quickly early in the lifetime of the materials and become somewhat more linear over time. However, the aging of the& blue material at a higher temperature accelerates somewhat later in the material's lifetime. A temperature-dependent aging rate is clearly shown by the divergent slopes of the same materials aged at different temperatures. Moreover, the initial correction value at cumulative charge zero for each color is different for each of the materials aged at different temperatures, indicating that the manufacturing process control is inadequate to maintain a consistent efficiency from device to device. All of these devices were aged at 120 cd/m² and their voltage correction value measured at 40° C.

It is clear from these results that knowledge of the initial luminance and the operating temperature of the OLED device is preferably applied to provide an effective correction scheme for an OLED device. However, in some circumstances, the operating temperature may be assumed.

Applicants have also demonstrated through experimentation that the rate of degradation is dependent riot only on cumulative charge and the temperature, but also on the current density of the OLED device as it is aged. This dependence is non-linear. Referring to Table 1, data is shown for one sample material used in five different devices and aged at two different current densities of 20 mA/cm² and 80 mA/cm².

TABLE 1

| | Time to T50 at | Time to T50 at |
|---|---|---|
| OLED Device | 20 mA/cm² | 80 mA/cm² |
| Device 1 | 2846 hours | 336 hours |
| Device 2 | 3067 hours | 358 hours |
| Device 3 | 3079 hours | 346 hours |
| Device 4 | 3165 hours | 367 hours |
| Device 5 | 3066 hours | 351 hours |
| Average | 3045 hours | 352 hours |

As noted in the table the average lifetime to T50 (the time required for the OLED device to drop to 50% of the initial luminance) for 20 mA/cm² is 3045 hours and at 80 mA/cm² the average lifetime to T50 is 352 hours. The total amount of current passed through the device at for 80 mA/cm² is four times the total amount of current passed through the device at 20 mA/cm². However, the ratio of the average lifetimes of the devices is 8.65:1, not 4:1 as would be expected and as stated in the prior art. Hence, a useful compensation scheme for OLED aging will rely on the present age of the OLED device, the operating temperature, and the current density (not simply the cumulative charge). An empirically derived transform can be employed to correct for the temperature and the luminance value in accumulating an aging value, as is taught in the present invention and performed by the transformation circuits 30 and 64. For example, a function of the form:
R=agefunc{tempfunc(curden(CV), Temp),AccumAge)}
may be used where R is the correction value, Temp is the operating temperature of the OLED device, CV is the corrected input signal, function curden is a conversion of the corrected input signal to current density through an OLED element (luminance), tempfunc is a function combining the operating temperature effect with the current density, and agefunc is a function that calculates the aging effect of the temperature-corrected aging factor with the aged state of the OLED device (AccumAge). The transformation performed by transformation circuit 44 may have a form:
Corrected Input Signal=Transform(R,Temp)

Because the initial performance of an OLED device can vary, an initial calibration step is useful. In an enhanced implementation of the present invention, the calibration step can include the additional steps of driving the OLED device for a fixed period of time at one or more luminance levels and measuring the light output from the device at the beginning and end of the fixed time period. Moreover, it can be helpful to drive the OLED device to the original light output level at the end of the fixed time period and measure the current and/or voltage necessary to achieve this light output. These empirically determined values can be used as the initial basis for correction factors used in either the first or second calculation circuits. Likewise, initial uniformity values may be used in the first calculation circuit to optimize the calculation accuracy. An explicit calibration measurement of this value removes unwanted noise factors from a calculation based on a theoretical model. Further examples of calculating aging functions for OLED devices which may be employed in accordance with the present invention are described, e.g., in copending, commonly assigned U.S. Ser. No. ______ (Kodak Docket 88274), the disclosure of which is incorporated by reference herein.

While the calibration process described above includes a measurement at the beginning and end of a fixed time period, in an alternative embodiment additional measurements are made at intervals during the period. These additional measurements may be used to more carefully establish the relationship between current, voltage, and light output of the OLED device and leads to a more robust correction process. Alternatively, the light output may be measured and the calibration process continued until the light output has decreased by a fixed, pre-determined amount (for example 10%). After the light output has decreased by the pre-determined amount, the current and voltage values may be measured and the degradation rate for the OLED device determined.

It is possible to employ the present invention to achieve an improved color balance of a color OLED device during its life. The calibration and correction process described above may be employed for each group of light emitting elements of a common color. Since the degradation characteristics of an OLED light emitter depend on the light emitting material, and since different materials may be employed to produce different colors of light, the colors in a color OLED having different materials will age at different rates. By correcting for each color separately with separate correction factors, the present invention can maintain a consistent color balance or white point for the OLED device.

In one embodiment, the OLED device is a color image display comprising an array of pixels, each pixel including a plurality of different colored light emitting elements (e.g. red, green and blue) that are individually controlled by a controller circuit to display a color image. The colored light emitting elements may be formed by different organic light emitting materials that emit light of different colors, alternatively, they may all be formed by the same organic white light emitting materials with color filters over the individual elements to produce the different colors. In another embodiment, the light emitting elements are individual graphic elements within a display and may not be organized as an array. In either embodiment, the light emitting elements may have either passive- or active-matrix control and may either have a bottom-emitting or top-emitting architecture. For all of these embodiment, the present invention may be employed and requires only that separate accumulation values be employed for each of the light emitting elements.

If a correction combining uniformity correction and aging is employed, separate aging values must be accumulated for each light emitting element in the OLED device. In this case, the aging accumulator 34 must be responsive to an address signal specifying the light emitting element to be corrected. Likewise, the transformation circuit must be responsive to an address signal specifying the light emitting element to be transformed. In a second alternative, simplified embodiment, separate accumulated values are employed only for each color of light emitter so that the aging accumulator and transformation circuit are responsive to the color and the correction combines differential aging and overall device aging. In a third alternative, simplified embodiment of the present invention, neither uniformity nor color differential corrections are employed and an aging value is calculated independently of the spatial location or color of the light emitting elements. In this third embodiment, the accumulated aging values are not specific to locations or colors on an OLED device and simply represent the cumulative aging of the entire OLED device. In this simplified arrangement, global changes in the OLED device may be corrected, but changes specific to the location or color of each light emitting element may not be corrected. In another simplified embodiment, linear approximations may be employed for the aging, temperature, and luminance effects.

Over time the OLED materials will age, the resistance of the OLEDs increase, the current used at the given input image signal will decrease and the correction will increase. At some point in time, the transformation circuit 44 will no longer be able to provide an image signal correction that is large enough and the OLED device 10 will have reached the end of its lifetime and can no longer meet its brightness or color specification. However, the device will continue to operate as its performance declines, thus providing a graceful degradation. Moreover, the time at which the display can no longer meet its specification can be signaled to a user of the device when a maximum correction is calculated, providing useful feedback on the performance of the display.

The present invention can be employed in most top- or bottom-emitting OLED device configurations. These include simple structures comprising a separate anode and cathode per OLED and more complex structures, such as passive matrix displays having orthogonal arrays of anodes and cathodes to form pixels, and active matrix displays where each pixel is controlled independently, for example, with a thin film transistor (TFT). As is well known in the art, OLED devices and light emitting layers include multiple organic layers, including hole and electron transporting and injecting layers, and emissive layers. Such configurations are included within this invention.

In a preferred embodiment, the invention is employed in a device that includes Organic Light Emitting Diodes (OLEDs) which are composed of small molecule or polymeric OLEDs as disclosed in but not limited to U.S. Pat. No. 4,769,292, issued Sep. 6, 1988.to Tang et al., and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

1. A system for controlling an OLED device having an output that changes with time or use comprising:
a) an OLED device responsive to a corrected input signal having one or more light emitting elements and a temperature sensor for sensing the temperature of the OLED device to produce a temperature signal;
b) a controller including:
i) a first calculation circuit responsive to the temperature signal, a corrected digital input signal, and a predetermined aging function to produce a digital aging value corresponding to the aging of the light emitting elements;
ii) an accumulation circuit for integrating the digital aging value over time to provide a digital accumulated aging value;
iii) a second calculation circuit responsive to the digital accumulated aging value for calculating a digital correction signal; and
iv) a transformation circuit responsive to a digital input signal and the digital correction signal for transforming the digital input signal to the corrected digital input signal.

2. The OLED control system claimed in claim 1, wherein the transformation circuit comprises a lookup table.

3. The OLED control system claimed in claim 1, wherein the second calculation circuit calculates a new digital correction signal on a periodic basis.

4. The OLED control system claimed in claim 1, wherein the second calculation circuit calculates a new digital correction signal in response to an operational signal.

5. The OLED control system claimed in claim 1, wherein the second calculation circuit calculates a new digital correction signal when the digital accumulated aging value reaches a pre-defined threshold value.

6. The OLED control system claimed in claim 1, wherein the first calculation circuit, the accumulation circuit, the second calculation circuit, and the transformation circuit are integrated within a single integrated circuit.

7. The OLED control system claimed in claim 1, wherein the accumulation circuit comprises an accumulator and a memory.

8. The OLED control system claimed in claim 7, wherein the accumulation circuit comprises a non-volatile memory.

9. The OLED control system claimed in claim 1, wherein the controller comprises a programmable, computing device.

10. The OLED control system claimed in claim 1, wherein the OLED is a color OLED having light emitting elements of two or more different colors.

11. The OLED control system claimed in claim 1, further comprising a light emitting element uniformity signal and a storage circuit for storing the uniformity signal, and wherein the second calculation circuit is responsive to the stored uniformity signal for calculating the digital correction signal.

12. The OLED control system claimed in claim 11, wherein the uniformity signal is a function of the intensities of light emitted by the light emitting elements.

13. The OLED control system claimed in claim 11, wherein the first calculation circuit is responsive to the uniformity signal for calculating the digital aging value.

14. The OLED control system claimed in claim 1, wherein the transformation circuit is responsive to the location of the light emitting element associated with the input signal.

15. The OLED control system claimed in claim 14, wherein a different transformation is performed for each light emitting element in the OLED device.

16. The OLED control system claimed in claim 1, wherein the first calculation circuit is responsive to the location of the light emitting element associated with the input signal.

17. The OLED control system claimed in claim 1, wherein a separate digital accumulated aging value is stored for each light emitting element in the OLED device.

18. The OLED control system claimed in claim 1, wherein the first calculation circuit is also responsive to the digital accumulated aging value.

19. A system for the control and correction of an OLED device having one or more light emitting elements having an output that changes with time or use comprising a single input signal transformation circuit for the correction of non-uniformity within the OLED device, overall aging of the overall OLED device, and differential light emitting element aging of the overall OLED device.

20. A method for controlling an OLED device having one or more light emitting elements having an output that changes with time or use, comprising:
a) determining an aging function for the light emitting elements of the device;
b) driving the OLED device with a corrected digital input signal;
c) measuring the temperature of the OLED device;
d) calculating a digital aging value from the aging function, measured temperature and the corrected digital input signal;
e) accumulating and storing a digital accumulated aging value by integrating the digital aging value over time;
f) calculating a digital correction signal for the OLED device using the aging function and the digital accumulated aging value; and
g) correcting a digital input signal with the digital correction signal to form the corrected digital input signal.

21. The method claimed in claim 20, further comprising storing a uniformity correction signal, and wherein the calculation of the digital correction signal further includes using the uniformity correction signal.

22. The method claimed in claim 20, wherein the OLED device has a plurality of light emitting elements and each of the light emitting elements is driven separately and a separate digital correction signal is calculated and applied for each light emitting element.

23. The method claimed in claim 20, wherein the OLED device has a plurality of light emitting elements and at least one of the light emitting elements emits light of one color and at least one of the light emitting elements emits light of another different color and wherein the light emitting elements of one color are driven separately from the light emitting elements of the different color and a separate digital correction signal is calculated and applied for each color of light emitting element.

24. The method claimed in claim 20, wherein the digital correction signal is applied with a lookup table.

25. The method claimed in claim 20, wherein the OLED device has a plurality of light emitting elements divided into at least two groups of light emitting elements, where the elements in each group are defined by their location on the display and a separate digital correction signal is calculated and applied for each group of light emitting elements.

26. The method claimed in claim 25, wherein the groups are rows or columns of light emitting elements.

27. The method claimed in claim 20, wherein a plurality of aging functions are determined at a plurality of light levels.

28. The method claimed in claim 27, wherein the digital correction signal for drive signals at light levels not corresponding to determined aging functions are interpolated -from digital correction signals calculated with determined aging functions.

29. The method claimed in claim 20, wherein step a) is performed before the OLED device is put into service.

30. The method claimed in claim 20, wherein the digital correction signal is restricted to be monotonically increasing.

31. The method claimed in claim 20, wherein a change in a calculated digital correction signal from a previously calculated digital correction signal is limited to a pre-determined maximum change.

32. The method claimed in claim 20, wherein the digital correction signal is applied to maintain a constant average luminance output for the OLED device over its lifetime.

33. The method claimed in claim 20, wherein the digital correction signal is calculated to maintain a decreasing level of luminance over the lifetime of the OLED device, but at a rate slower than that of an uncorrected OLED device.

34. The method claimed in claim 20, wherein the digital correction signal is calculated to maintain a constant white point for the OLED device over its lifetime.

35. The method claimed in claim 20, further comprising the step of providing an end-of-life signal when the calculated digital correction signal exceeds a predetermined level.

36. The method claimed in claim 20, wherein the digital correction signal is changed periodically, at power-up, at power-down, or in response to the digital accumulated aging value.
